(19) United States
(12) Patent Application Publication
(10) Pub. No.: US 2020/0177660 A1
(43) Pub. Date: Jun. 4, 2020

(54) OFFLOAD OF STREAMING PROTOCOL PACKET FORMATION

(71) Applicant: Intel Corporation, Santa Clara, CA (US)

(72) Inventors: Patrick CONNOR, Beaverton, OR (US); James R. HEARN, Hillsboro, OR (US); Kevin LIEDTKE, Portland, OR (US)

(21) Appl. No.: 16/780,609

(22) Filed: Feb. 3, 2020

(51) Int. Cl. H04L 29/06; H04L 12/801; H04L 12/853; H04L 29/08

(52) U.S. Cl. CPC H04L 65/608; H04L 47/34; H04L 69/166; H04L 47/2416; H04L 69/326; H04L 69/22

(57) ABSTRACT

Examples described herein relate to providing a streaming protocol packet segmentation offload request to a network interface. The request can specify a segment of content to transmit and meta data associated with the content. The offload request can cause the network interface to generate at least one header field value for the packet and insert at least one header field prior to transmission of the packet. In some examples, the network interface generates a validation value for a transport layer protocol based on the packet with the inserted at least one header field. Some examples provide for pre-packetized content to be stored and available to copy to the network interface. In such examples, the network interface can modify or update certain header fields prior to transmitting the packet.

Streaming media, such as streaming audio or video, is consuming an increasing percentage of Internet traffic. Servers and data centers that host and serve media generate packets to transmit the media to remote client devices. Real Time Streaming Protocol (RTSP) is a protocol used to establish and control media sessions. RTSP includes functions such as play, record, and pause to facilitate real-time control of the media streaming from the server to a client such as video-on-demand. Other control protocols (also known as signaling protocols) include H.323, Session Initiation Protocol (SIP), RTSP, and Jingle (XMPP).

### BRIEF DESCRIPTION OF THE DRAWINGS

FIG. 1A depicts an example of a system.

FIG. 1B depicts an example system.

FIG. 2 depicts an example of formation of a packet using data and various headers.

FIG. 3 depicts an example of an RTP packet header.

FIG. 4A depicts a process performed by an operating system to discover and request RTP segmentation offload transmit operations.

FIG. 4B depicts an example process performed by a device driver in connection with RTP segmentation offload command performance.

FIG. 4C depicts an example process performed by a network interface controller in connection with RTP segmentation offload command performance.

FIG. 5 depicts a system that can be used to store pre-packetized content of streaming video and provide the content to one or more client devices.

FIG. 6A depicts an example where a file is stored as multiple packets for multiple formats.

FIG. 6B depicts an example of adjusting between stream qualities due to changes in bandwidth availability between the transmitter and client.

FIGS. 7A and 7B depict processes that can be performed to transmit pre-packetized files.

FIG. 8 depicts a system.

FIG. 9 depicts an example environment.

### DETAILED DESCRIPTION

Real-time Transport Protocol (RTP) is used in conjunction with Real-time Control Protocol (RTCP) for media stream delivery. RTP carries the media streams (e.g., audio and video), whereas RTCP is used to monitor transmission statistics and quality of service (QoS) and aids in the synchronization of audio and video streams. RTP is designed to be independent from the media format. Supported audio payload formats include, but are not limited to, G.711, G.723, G.726, G.729, GSM, QCELP, MP3, and DTMF. Video payload formats include, but are not limited to, H.261, H.263, H.264, H.265, and MPEG-1/MPEG-2. For example, some media streaming services use the Dynamic Streaming over HTTP (DASH) protocol or HTTP Live Streaming (HLS). Packet formats to map MPEG-4 audio/video into RTP packets is specified in RFC 3016. RTCP facilities for jitter compensation and detection of packet loss and out-of-order delivery, which are common especially during User Datagram Protocol (UDP) transmissions over the internet. Under some uses, the bandwidth of the control protocol (e.g., RTCP) traffic compared to media (e.g., RTP) is typically less than 5%.

Streaming content involves packetizing the content by one or more of the following: creating headers, segments, encapsulation, calculating checksums, cyclic redundancy check (CRC), version bits, protocol indicators, frame markers, encryption, adding padding, payload type indicators (e.g., see RFC 3551), sequence numbers, timestamps (e.g., video streams typically use a 90 kHz clock), synchronization source identifier (e.g., Multiple Synchronization sources (SSRC)), contributing source identifier (CSRC), length indicators, and more. In short, packetizing the data still involves a significant amount of work.

For processing of media traffic, protocol processing and packetization work is commonly performed in software executed by a central processing unit (CPU) in real time as part of every single connection and upload/download of the media. However, CPU cycles available for processing and transmitting the stream limits the number of streams that a single core can transmit. Moreover, CPU utilization is also impacted by transmitted segment size such that higher segment size (e.g., data transmitted in a packet) can also increase CPU utilization.

Some solutions reduce a burden on a CPU to transmit traffic by using segmentation offloading. Segmentation offloading moves the burden of packetization from CPU-executed software to the network controller (NIC). This can increase throughput and reduce CPU utilization drastically for many transfer types. Segmentation offload is supported in Windows®, Linux®, VMware® environments, and other operating systems. For example, Transmission Control Protocol (TCP) segmentation offload (TSO) can be used to offload packet formation to a NIC.

When a packet generated from a TCP segmentation offload (TSO) operation is sent, the packets are generated and transmitted in rapid succession. This means that they typically have minimal inter-frame spacing and travel through the infrastructure in a burst or a packet train. An example TCP offload (TSO) flow is described next. At 1, the operating system (OS) sends the network device driver a TSO transmit command with a pointer to a congestion window worth of data (typically up to 64 KB) to be sent. This TSO command includes pointers to prototype headers (e.g., a template header with some header fields completed and having the proper length), pointers to the data buffers, and metadata including the header types (e.g., TCP, UPD, IPv4, IPv6), segment size to use, window length. Prototype headers have static fields filled in and initial values for fields such as sequence numbers that will be updated in each packet to refer to the proper sequence number based on prior sequence numbers so as to identify sequence numbers of transmitted packets. At 2, the device driver reads the TSO command and prepares a context descriptor to inform the NIC about the metadata prototype headers. At 3, the device driver prepares data descriptors that indicates where each data buffer is, its length, and which context slot/flow it is associated with.

At 4, the device driver queues the descriptors for the NIC. At 5, the network interface controller (NIC) reads the descriptors and at 6, the NIC reads the prototype headers. At 7, the NIC, for each packet: creates a copy of the prototype headers, writing it into the transmit (TX) first in first out (FIFO) buffer; reads a segments worth of data (e.g., 1440 bytes) from system memory and writes it into the TX FIFO (appending it to the copy of the prototype header; updates headers for this packet including: sequence number, IP header length (the final packet may be shorter than others in the window), checksums (IP and TCP), TCP flags (some flags do not change, whereas others are only set in the first or final packet); and queues the packet for egress.

At 8, the NIC indicates to the device driver that the transmit operation is complete (typically via an interrupt and descriptor done-bit in the status field). At 9, the device driver indicates to the OS that the TSO transmit command is complete. At 10, resources are freed (memory pages that were locked to a physical address for DMA are released). At 11, Transmit Control Block (TCB) for the associated TCP connection is updated.

However, for RTP protocol (and similar streaming protocols), packetization is performed by CPU-executed software and TSO is not used for these streaming protocols. Streaming protocols cannot utilize TSO because of packet pacing and TSO does not generate dynamic header fields such as time stamps and validation indicators (e.g., checksums or CRC values). In addition, streaming media uses metered data transmission pace whereas TSO provides clumpy and bursty data transmission.

Various embodiments extend transport layer segmentation offload to allow header and packet formation offload to a NIC for streaming protocols (e.g., RTP, DASH, HLS). Various embodiments provide streaming header replication and updating during transport layer segmentation or fragmentation offload to a NIC. For example, dynamic generation or updating of streaming header fields such as timestamps and checksums are offloaded to a NIC or SmartNIC. Various embodiments provide segmentation offload for the underlying transport layer (e.g., TCP, UDP, QUIC) for streaming protocols such as RTP and provide header updates and time metering (e.g., packet pacing) at the NIC. UDP datagrams can be broken into multiple IP fragments. A QoS or packet pacing features of a NIC can provide packet pacing used for some streaming protocols. However, if packet pacing is not used (such as when buffering), then streaming content can be sent according to bursts.

Various embodiments provide a device driver and device driver development kits (DDK) that permit use of application program interfaces (APIs) or use of offload of packet formation or modification for streaming protocol traffic using a network interface.

Various embodiments attempt to optimize the processing of streaming media traffic (e.g., audio, video, sensor data (e.g., autonomous vehicle), telemetry data) by reducing CPU or core utilization for header preparation and processing during transmission of streaming media content. Various embodiments can reduce cycles per byte, which can measure CPU cycles used to prepare a packet for transmission to a network. A content delivery network (CDN) that provides streaming services can use various embodiments. CDNs can save significant CPU resources when streaming content. Various embodiments will enable CDNs to serve more connections and/or realize power/heat savings.

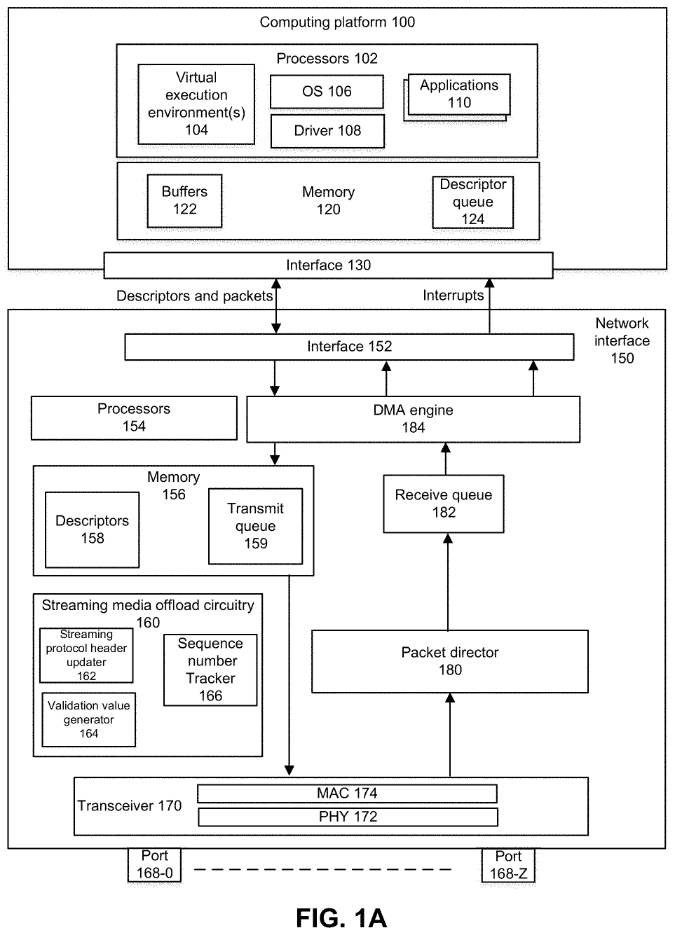

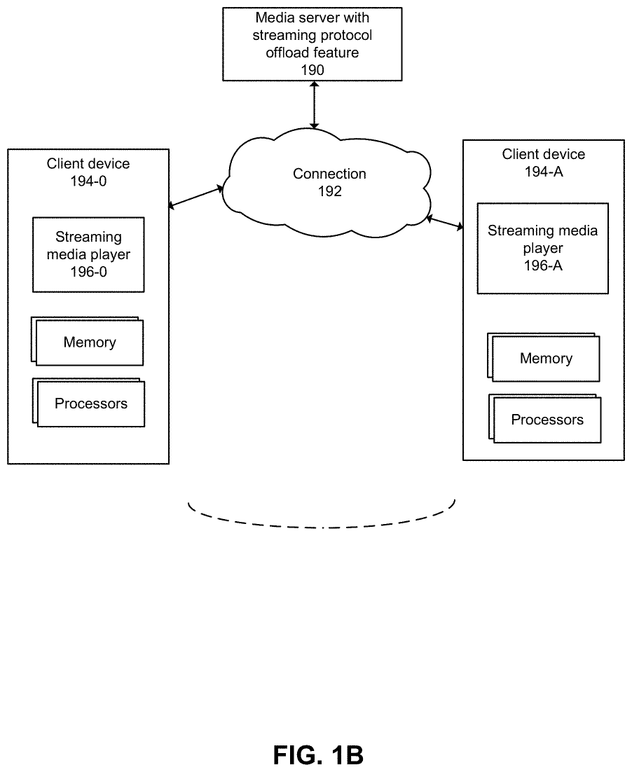

FIG. 1A depicts an example of a system. In this system, a computing platform 100 can generate packets for transmission by offloading various packet header generation or modification tasks to a network interface 150. Computing platform 100 can include various processors 102 and memory 120. Processors 102 can execution virtual execution environment 104, operating system 106, network interface driver 108, and applications 110.

Processors 102 can be an execution core or computational engine that is capable of executing instructions. A core can have access to its own cache and read only memory (ROM), or multiple cores can share a cache or ROM. Cores can be homogeneous and/or heterogeneous devices. Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Processors 102 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein.

A virtualized execution environment can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can be an OS or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux® and Windows® Server operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. Isolation can include permitted access of a region of addressable memory or storage by a particular container but not another container. The isolated nature of containers provides several benefits. First, the software in a container will run the same in different environments. For example, a container that includes PHP and MySQL can run identically on both a Linux computer and a Windows® machine. Second, containers provide added security since the software will not affect the host operating system. While an installed application may alter system settings and modify resources, such as the Windows® registry, a container can only modify settings within the container.

In some examples, operating system 106 can be any of Linux®, Windows® Server, FreeBSD, Android®, MacOS®, iOS®, or any other operating system. Operating system 106 can run within a virtual execution environment 104 or outside of virtual execution environment 104. Driver 108 can provide an interface between virtual execution environment 104 or operating system (OS) 106 and network interface 150. In some examples, OS 106 queries device driver 108 for capabilities of network interface 150 and learns of an RTP Segmentation Offload (RTPSO) feature whereby network interface 150 can generate one or more header fields of an RTP packet header and one or more header fields of a TCP header (or other streaming protocol or transport layer header).

Applications 110 can be any type of application including media streaming application (e.g., video or audio), virtual reality application (including headset and sound emitters), augmented reality application, video or audio conference application, video game application, telemetry detection device (e.g., running collected daemons), or any application that streams content to a receiver. In some examples, applications 110 run within a virtual execution environment 104 or outside of virtual execution environment 104. In response to an indication of availability of data or content to be transmitted using RTP from application 110, OS 106 sends network device driver 108 an RTPSO transmit command. The RTPSO transmit command can have an associated pointer to the lesser of: a congestion window worth of data or X milliseconds of content to be sent. The RTPSO transmit command can include a pointer to a prototype header in memory 120, pointer to a location in data buffer 122 that stores the content, and metadata. A prototype header can include completed RTP, TCP, IPv4 fields but leave some fields empty or with dummy data. Metadata can include one or more of: header types, TCP segment size, total data bytes to send, transmit rate, an initial timestamp value, a clock rate at which the RTP timestamp increments.

In response to receipt of an RTPSO command, device driver 108 prepares descriptors in descriptor queue 124 for an RTPSO transaction. Device driver 108 can prepare a context descriptor to inform network interface 150 of related metadata and a prototype header. Device driver 108 can prepare a data descriptor that identifies one or more of: a memory address of a data buffer, length of content to transmit, and an associated RTPSO context slot. Device driver 108 queues the descriptors for network interface 150 to retrieve in descriptor queue 124.

Interface 130 and interface 152 can provide communicative coupling between platform 100 and network interface 150. For example, communicative coupling can be based on Peripheral Component Interconnect express (PCIe) or any public or proprietary standard.

Network interface 150 can include or access processors 154 and memory 156 to store at least data, prototype header, meta data and descriptors. DMA engine 184 can be used to copy descriptors or data to memory 156 or to memory 120. For example, descriptors and meta data can be stored in descriptor buffer 158. Transmit queue 159 can store the prototype header and content for transmission in a packet.

Streaming media offload circuitry 160 can use streaming protocol header updater 162 to update one or more of: sequence number and timestamp fields of an RTP prototype header stored in transmit queue 159. Streaming media offload circuitry 160 can use sequence number tracker 166 to generate a first sequence number for a connection (e.g., a random value) or a sequential sequence number. Timestamp fields can be generated based on the initial timestamp value and clock rate in the metadata from computing platform 100. Streaming media offload circuitry 160 can use validation value generator 164 to generate a validation value (e.g., checksum or CRC value) for a TCP packet based on the RTP header state after sequence number or timestamp fields are updated. Streaming media offload circuitry 160 can be implemented as programs executed by processor 154, application specific integrated circuit (ASIC), field programmable gate arrays (FPGAs), or programmable or fixed function devices. Note that a streaming media protocol can different from TCP by providing metered and rate-controlled content transfer as opposed to TCP's bursty and un-metered packet transmission.

Based on a completed transmission of an RTP segment in a packet, network interface 150 indicates to device driver 108 that the transmit operation is complete. Device driver 108 indicates to OS 106 that the TSO transmit command is complete and resources can be freed (e.g., memory). In addition, a Transmit Control Block (TCB) for the associated TCP connection can be updated to identify a transmitted TCP segment.

A packet can refer to various formatted collections of bits that may be sent across a network, such as Ethernet frames, IP packets, TCP segments, UDP datagrams, RTP segments, and so forth. References to L2, L3, L4, and L7 layers (or layer 2, layer 3, layer 4, and layer 7) are references respectively to the second data link layer, the third network layer, the fourth transport layer, and the seventh application layer of the OSI (Open System Interconnection) layer model.

A packet can be associated with a flow. A flow can be one or more packets transmitted between two endpoints. A flow can be identified by a set of defined tuples, such as two tuples that identify the endpoints (e.g., source and destination addresses). For some services, flows can be identified at a finer granularity by using five or more tuples (e.g., source address, destination address, IP protocol, transport layer source port, and destination port).

Description next turns to a receive path for packets received by network interface 150. Network interface 150 includes one or more ports 168-0 to 168-Z. A port can represent a physical port or virtual port. A packet received at a port 168-0 to 168-Z is provided to transceiver 170. Transceiver 170 provides for physical layer processing 172 and MAC layer processing 174 of received packets in accordance with relevant protocols.

Packet director 180 can apply receive side scaling to determine a receive queue and associated core in computing platform 100 to process a received packet. Packet director 180 causes the received packets to be stored into receive queue 182 for transfer to platform 100.

Direct memory access (DMA) engine 184 can transfer contents of a packet and a corresponding descriptor from descriptor queues 158 to memory 120. For example, a portion of the packet can be copied via DMA to a packet buffer in memory 120. Direct memory access (DMA) is a technology that allows an input/output (I/O) device to bypass a central processing unit (CPU) or core, and to send or receive data directly to or from a system memory. Because DMA allows the CPU or core to not manage a copy operation when sending or receiving data to or from the system memory, the CPU or core can be available to perform other operations. Without DMA, when the CPU or core is using programmed input/output, the CPU or core is typically occupied for the entire duration of a read or write operation and is unavailable to perform other work. With DMA, the CPU or core can, for example, initiate a data transfer, and then perform other operations while the data transfer is in progress. The CPU or core can receive an interrupt from a DMA controller when the data transfer is finished.

DMA engine 184 can perform DMA coalescing whereby the DMA engine 184 collects packets before it initiates a DMA operation to a queue in platform 100. Receive Segment Coalescing (RSC) can also be utilized whereby content from received packets is combined into a packet or content combination. Interrupt moderation can be used to determine when to perform an interrupt to inform platform 100 that a packet or packets or references to any portion of a packet or packets is available for processing from a queue. An expiration of a timer or reaching or exceeding a size threshold of packets can cause an interrupt to be generated. An interrupt can be directed to a particular core that is intended to process a packet.

FIG. 1B depicts an example system whereby a media server 190 can use streaming protocol offload features described herein to provide content to one or more client devices 194-0 to 194-A via a connection 192. Any of client devices 194-0 to 194-A can use a streaming media player 196-0 to 196-A to display and control which media to retrieve and where in the media to begin playback from. Connection 192 can provide communication with any network, fabric, or interconnect such as one or more of: Ethernet (IEEE 802.3), remote direct memory access (RDMA), InfiniB and, Internet Wide Area RDMA Protocol (iWARP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

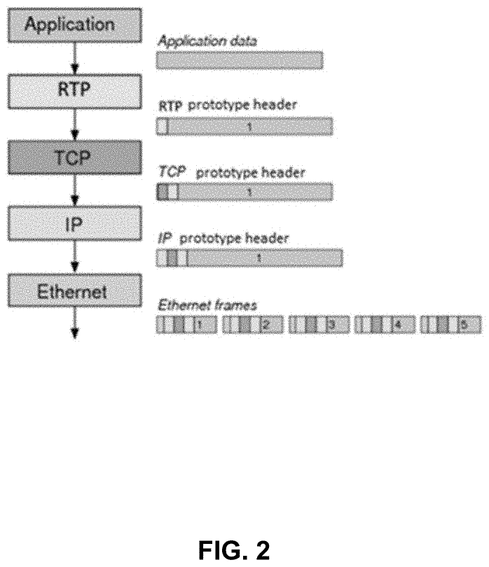

FIG. 2 depicts an example of formation of a packet using data and various headers. Various embodiments allow a network interface to add streaming headers such as RTP-related headers in a packet and to pace traffic transmission according to the applicable streaming control protocol. An example of RTP over TCP/IP via Ethernet frames is depicted. However, UDP/IP or quick UDP Internet Connections (QUIC)/UDP/IP may be used in other implementations. An RTP prototype header (e.g., template header) can be appended to application data such as a media file. A TCP or other protocol header can be formed and appended to the combination of the RTP prototype header with application data. In addition, an IP header can be formed and appended to the combination of the TCP header with the RTP prototype header with the application data. Ethernet frames can be formed to transmit various application data encapsulated using IP, TCP, and RTP headers. Of course, other protocols can be used.

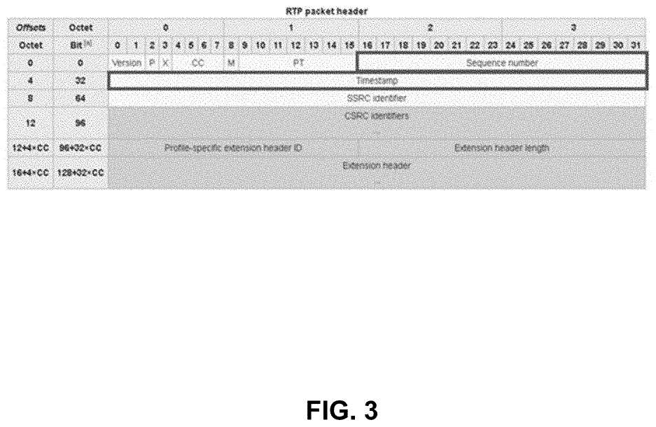

FIG. 3 depicts an example of an RTP packet header. According to some embodiments, a network interface can generate and insert sequence number and timestamp fields in an RTP packet header template. In a packet header template, the sequence number and timestamp fields can be left blank or include dummy data to be overwritten. According to RFC 3550 (2003), RTP states that the initial value of the RTP sequence number be a random or pseudo-random value to make known-plaintext attacks on encryption more difficult. A random value can be generated at connection setup and included as an initial value in the context for a given flow. According to some embodiments, generation of the starting sequence value and subsequent sequence values can be performed by a network interface. The network interface can generate an initial value and maintain per flow-state to track and provide the sequence number, even after the first sequence number, of one or more flows.

According to some embodiments, offload to the network interface occurs at least for generation of timestamps and data verification fields (e.g., checksums) as fields in a packet are updated prior to transmission and recalculated by the network interface. Accordingly, in addition to an Ethernet network interface controllers performing generation of some TCP/UDP/IP header fields (e.g., checksum), the controller can generate header updates for streaming protocols such as RTP. For example, for UDP, a checksum can be generated over a portion of a packet (e.g., packet and/or header).

Secure Real-time Transport Protocol (SRTP) (RFC 3711 (2004)) defines an RTP profile that provides cryptographic services for the transfer of payload data. When this service is used, the cryptographic encoding may be performed as part of pre-processing or may be offloaded to the network interface. For example, generation of a validation value (e.g., TCP checksum header field) over a packet can be performed by a network interface after sequence number and time stamps are generated.

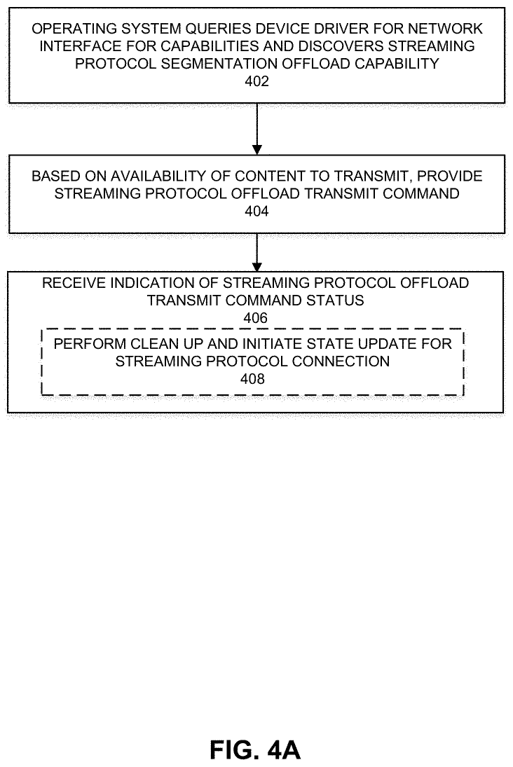

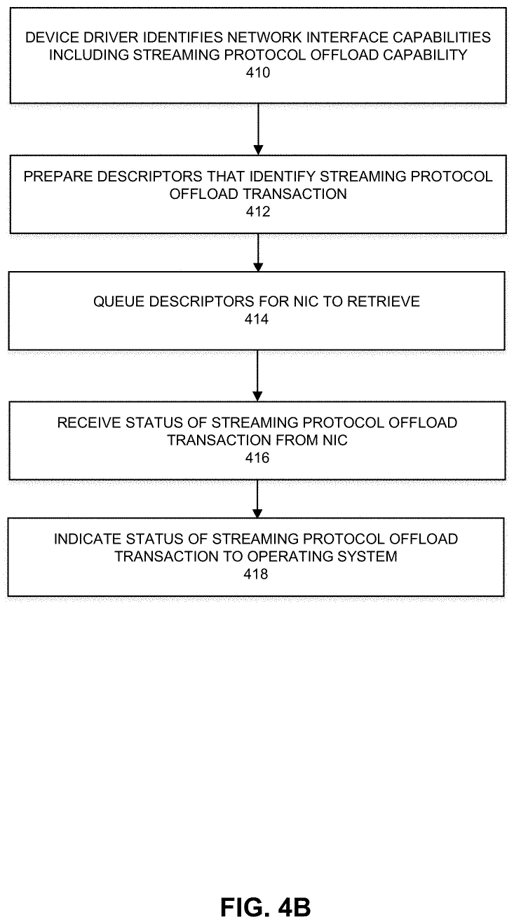

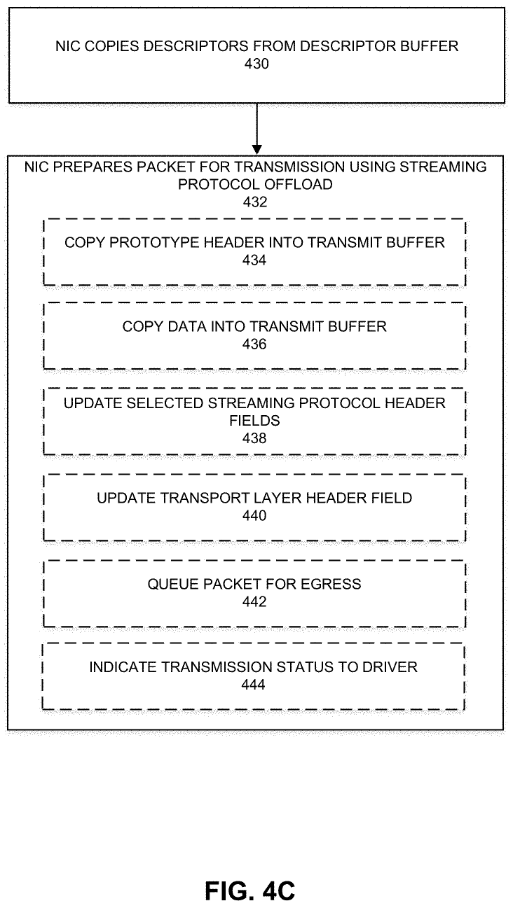

FIG. 4A depicts a process performed by an operating system to discover and request streaming protocol transmit operations. At 402, the OS queries the device driver for capabilities of NIC and learns of a streaming protocol offload feature. When installing a new network interface (e.g., virtual or physical), OS discovers capabilities of a NIC via a driver. The device driver can notify an OS of RTPSO feature.

At 404, in response to an indication of availability of data or content to be transmitted using a streaming protocol, the OS sends the network device driver a streaming protocol offload transmit command. The streaming protocol offload transmit command can be an RTP Segmentation Offload (RTPSO) command. A streaming protocol offload transmit command can have an associated pointer to the lesser of, a TCP congestion window worth of data (typically up to 64 KB) or the X milliseconds of content to be sent. A streaming protocol offload transmit command can include a pointer to a prototype headers, pointer to a data buffer that stores the content, and metadata. A prototype header can include RTP, TCP, IPv4 fields completed and some fields empty or with dummy data. Metadata can include header types, TCP segment size, total bytes to send (data bytes, not including headers), pacing information (e.g., 3 Mbps), initial timestamp value (this could be in the RTP prototype header or the metadata), clock rate (the rate at which the RTP timestamp increments, typically 8k to 90k Hz).

At 406, the OS receives an indication of streaming protocol offload transmit command status and performs a state update. The device driver can indicate to the OS that the command transmit command has completed or has failed. In the event of a failure, the OS can request another RTPSO transmit command with the same content. Based on an indication that the streaming protocol offload transmit command was successfully completed, at 408, the OS can perform cleanup and initiate state update. The OS frees resources such as memory pages that were locked to a physical address for DMA are released. A Transmit Control Block (TCB) for the associated TCP connection is updated and the RTCP is updated with the completed RTPSO information.

FIG. 4B depicts an example process performed by a device driver in connection with performance of a streaming protocol offload transmit command. At 410, the device driver identifies network interface capabilities including streaming protocol segmentation offload. At 412, in response to receipt of a streaming protocol offload transmit command, the device driver prepares descriptors for a streaming protocol offload transmit transaction. The device driver, in one feature, prepares a context descriptor to inform the network interface of related metadata and prototype headers of a streaming protocol offload transmit transaction to undertake. The device driver can prepare a data descriptor that identifies a memory address of a data buffer, length of content to transmit, and an associated streaming protocol offload transmit context slot. At 414, the device driver queues the descriptors for the NIC to retrieve. A descriptor can identify a segment worth of data to transmit.

At 416, the device driver receives indication of status of the transmit operation. A status update can occur via an interrupt and descriptor done-bit in the status field. The status update can indicate whether the transmit operation completed or was unsuccessful. At 418, the device driver indicates to the OS that the streaming protocol offload transmit command is complete

FIG. 4C depicts an example process performed by a network interface controller in connection with performance of a streaming protocol offload transmit command. At 430, the NIC reads the descriptors from host computing system descriptor buffer and copies the descriptors into the NIC's descriptor buffer. At 432, the NIC processes a packet for transmission. Preparation of a packet using streaming protocol offload for transmission can include any of 434-444.

At 434, the NIC copies a prototype header into a transmit (TX) FIFO memory buffer. At 436, the NIC reads a segment worth of data from system memory and copies the data into the TX FIFO memory buffer. The segment is appended to the copy of the prototype header. For example, a segment worth of data can be 1428 bytes if there are no RTP extensions. However, a short packet can be sent or a padded packet can be sent. In some examples, the NIC can copy a page or 4 KB worth of data from system and internally copy the data to the NIC and access a segment worth of data.

At 438, the NIC updates at least one streaming protocol header portion of the prototype header. For example, the NIC can update one or more of the sequence number and timestamp fields of the RTP packet header. In some examples, a first sequence number used for a first RTP header in a connection can be a pseudo-randomly selected value in accordance with RFC 3550 (2003). For a subsequent RTP segment, the NIC increments the sequence number from its initial (random) value based on the number of RTP data bytes that have been sent. RTP sequence number updates can be different from the IP sequence number changes because the IP sequence number updates will include the TCP and RTP headers for each packet, but these bytes are not included in considering when to increment the RTP sequence number.

In some example, the timestamp in the streaming protocol header is updated based on the initial timestamp value, the clock rate, and the number of streaming protocol bytes sent so far. The timestamp value is relative to the content itself and is used by the client to play back the received samples at appropriate time and interval. By contrast, IEEE 1588 describes marking a time the packet was sent. However, any time stamp can be used in the streaming protocol header.

At 440, the NIC updates one or more transport layer header fields for the packet. In some examples, because the TCP checksum includes the RTP header and payload, the TCP checksum header field is generated after the RTP header field values (e.g., at least sequence number and time stamp) are determined for the packet. For example, checksum calculation is described in RFC 793 (1981). At 442, the packet is queued for egress.

At 444, the NIC indicates to the device driver that the transmit operation is complete (typically via an interrupt and descriptor done-bit in the status field). However, if the transmission operation is not completed, the NIC can indicate the transmit operation is not complete or retry the transmit.

### Pre-Packetizing Content

To stream media content, data centers or content delivery networks (CDN) open a media file, transcode the file to modify the encoding format to a format decodable by the client, and packetize the file to be transmitted to the client via various streaming protocols. CPU cycles are used to prepare media for transmission and preparation of media can occur for used every stream request. To reduce this overhead, streaming media providers can pre-transcode content into common resolutions or quality levels (e.g., 360p, 480p, 720p, 1080p, Ultra High Definition (UHD), 2k, 4k . . . ). These files of different resolutions or quality levels are saved as different versions of the media. When a streaming request arrives, the server selects the most appropriate version of the item to present the best streaming experience considering resources, bandwidth, quality and other considerations, but the content still has to be packetized before it is sent on the network. However, as CPU cycles are spent processing and transmitting the stream, the number of streams that a single core can transmit are limited. In hyperscale applications with many multitudes of client devices that receive streams, system scalability can be limited.

Various embodiments pre-process various resolutions or quality level versions of a file (e.g., video or audio), generate pre-packetized versions of the file, and store pre-packetized versions of the file. Server systems can be configured to pre-packetize files based on streaming protocol(s) they support and the most common packet sizes utilized for requests. Some of the packet protocol processing can be performed ahead of request time and only performed once, rather than for each stream. In this way, much of the latency and processing power used to take a file from block storage and prepare it for transmission using a network transport is performed once and ahead of request time. Preparing a file for network transport can avoid preparation of a file for transport every time the file is streamed to a remote client, which could be in the hundreds of thousands or millions of times for popular content. Various embodiments reduce latency or time spent preparing a packet for transmission and potentially reduce an amount of power and/or CPU cycles used to for packet transmission.

Various embodiments increase an amount of processing and packetization for streaming content that can be completed before a request occurs to reduce the effort on the CPU during streaming, thereby freeing the CPU up to serve other tasks while content is streamed. Generation of RTP header fields such as sequence numbers, time stamps, or transport layer header checksum can be offloaded to a NIC (or SmartNIC).

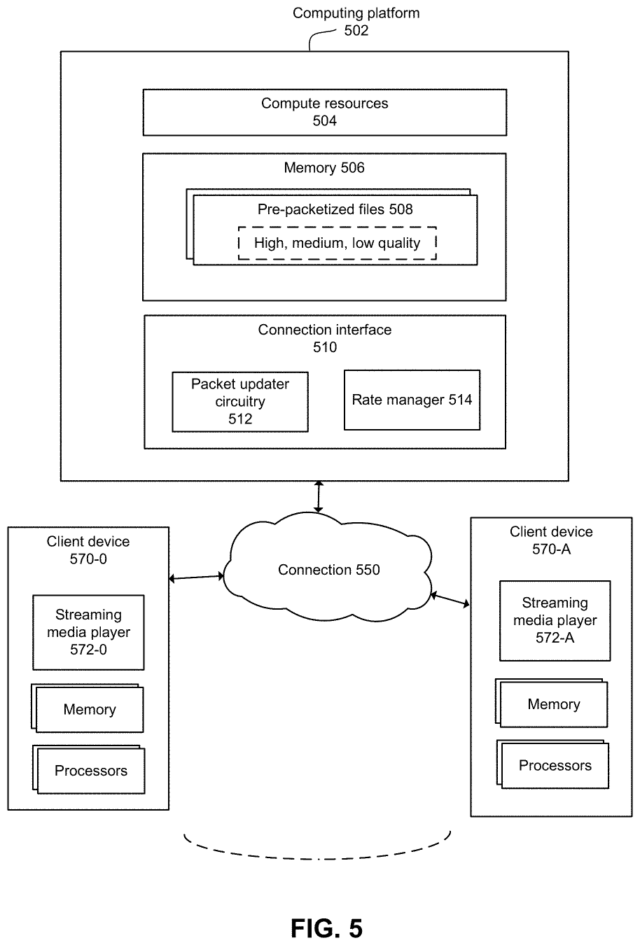

FIG. 5 depicts a system that can be used to store pre-packetized content of streaming video and provide the content to one or more client devices. Compute resources 504 can include any type of processor such as but not limited to one or more of: any type of microprocessor, central processing unit (CPU), graphics processing unit (GPU), processing core, ASIC, or FPGA. In some examples, compute resources 504 can use embodiments herein to generate packets that include media files (or other contents) for one or more level of definition or quality (e.g., high, medium and low quality) and these pre-generated packets are ready to transmit except for certain header fields that connection interface 510 is to generate using packet update circuitry 512.

In addition, or alternatively, media files can be pre-packetized for various video encoding formats. Video encoding formats can include one or more of: Moving Picture Experts Group (MPEG) formats such as MPEG-2, Advanced Video Coding (AVC) formats such as H.264/MPEG-4 AVC, H.265/HEVC, Alliance for Open Media (AOMedia) VP8, VP9, as well as the Society of Motion Picture & Television Engineers (SMPTE) 421M/VC-1, and Joint Photographic Experts Group (JPEG) formats such as JPEG, and Motion JPEG (MJPEG) formats.

Compute resources 504 can store the pre-generated packets of various levels of definition in memory 506. A file of a first level of definition is segmented into multiple pre-generated packets and stored in memory 506. The same file, but of one or more different levels of definition, can be segmented into multiple pre-generated packets and stored in memory 506. Memory 506 can represent a volatile, non-volatile or persistent memory or storage and non-limiting examples of memory 506 are described herein.

Compute resources 504 can transcode a file and pre-packetize the file and store the pre-packetized file in a local or remote memory prior to a request from a user for a file. In some examples, for a first request for a file, the entire file can be pre-packetized and stored so that a portion of the file is pre-packetized and ready to transmit to the same user, the same user at a later time, or a different user. A content provider could initiate pre-packetization of a file for various quality levels or encoding formats using a user interface-presented action prompt for a file such as “Save file in network/streaming ready format” or command entered by a network administrator through a command line interface. A cloud service provider (CSP) could offer a pre-packetization service to pre-packetize files of customers. In some examples, an operating system or virtualized execution environment can proactively pre-packetize media files. In some examples, live video feeds can be stored as pre-packetized content of one or more quality levels or encoding formats. For example, a pre-packetized content of a first quality level or encoding format can be stored in a file whereas pre-packetized content of a second quality level or encoding format can be stored in a second file.

Multiple pre-packetized files carry or include the same media (e.g., image, video, or audio (e.g., podcasts)) such as flashbacks, fade-to-black, program introductions (e.g., title and character introductions repeated throughout a series or season of a show), media credits, and so forth. In some examples, a reference pre-packetized file can be created and accessed and transmitted one or more times. For example, if series “Jet Fighters” share the same or similar media across episodes, one or more copies of a reference pre-packetized file can be reused. For example, if packet 23000 has the same content as packet 5, packet 23000 may not be stored but instead, an index, packet list, or location table can indicate to send packet 5 in place of packet 23000. Various embodiments can update timestamp and sequence number (and other fields) in a packet header of reused pre-packetized files. For example, if packet 5 is selected to be transmitted instead of a packet 23000, various headers of the packet 5 are updated to correspond with headers that would have been used for packet 23000.

Reference pre-packetized files can be used across programs or even series such that different programs share the same or similar media content. For example, if series “Jet Fighters” share the same or similar media with movie “Flying Aces,” one or more copies of a reference pre-packetized file can be reused across a series or movies.

In some examples, pre-packetized media or audio content could only be stored once or in multiple locations, rather than for multiple programs that include the same or similar content. Accordingly, storage space used for pre-packetized content can be reduced by identifying duplicate content and referring to a reference pre-packetized content to de-duplicate pre-packetized content.

Some multimedia compression is lossy, so some packets might not carry identical content and similar content can be acceptable as a substitute for the original. For example, for a lower quality level, a similar but not the same media could be transmitted. For example, MPEG video compression analysis can identify differences between media such that for less than a threshold level of differences, a pre-packetized file can be used for a program (at any quality level) or other different programs presented at lower quality.

A pre-packetized file can be a portion of a media that has certain packet header information created. The pre-packetized file can be stored and be available for transmission in response to a request for the portion of the media. Connection interface 510 can use packet update circuitry 512 to generate and update fields (e.g., sequence number, timestamp and checksum or CRC) for a packet in connection interface 510 prior to transmission. In some examples, files could be pre-packetized and stored in memory or storage as packets and to send packets to a receiver without updated by a network interface as the packets are formed and ready for transmission.

For a particular quality level, packets can be ordered for reading-out by use of a linked-list such that for a next time stamp or frame to be displayed, a list can proceed to an index of N+1 packet. However, switching to a next quality level can involve identification of a corresponding index in the next quality level to identify a next time stamp or frame to be displayed to preserve playback order. Conversion between indexes between different quality levels can be based on a percentage conversion, time stamp conversion, or scaled packet count whereby a conversion factor is applied to a current index level in a current quality level to determine an index in another quality level. For example, switching from high quality to medium quality can apply a conversion ratio of index_medium_quality=index_high_quality*K, where index_medium_quality is rounded down to a nearest integer.

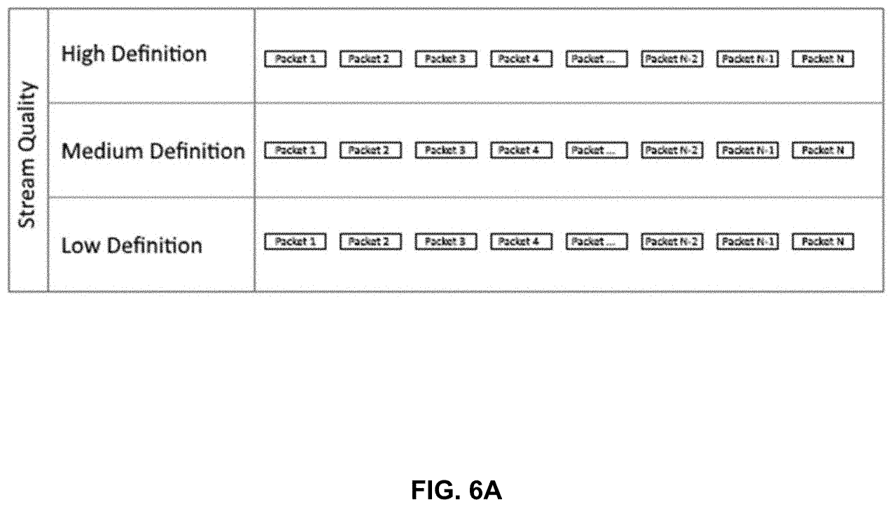

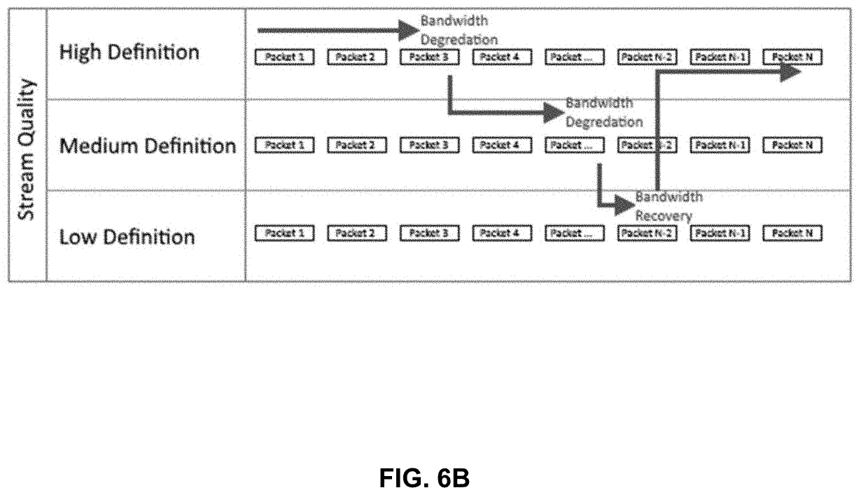

Connection interface 510 can include a network interface, fabric interface, or any type of interface to connection 550. Connection interface 510 can use rate manager 514 to dynamically determine whether to adjust a media quality level of a transmitted file based on feedback such as bandwidth conditions of connection 550. Connection interface 510 can cause compute resources 504 to dynamically shift between streaming of a file using pre-generated packets to a second video quality level using pre-generated packets of the second video quality level while maintaining time stamp ordering to ensure continuous time playback at the client device. Examples provided with respect to FIGS. 6A and 6B demonstrate an example of shifting between different video qualities while maintaining time stamp ordering using pre-generated packets. Additionally, the stream may switch to and from pre-packetized content and non-pre-packetized content depending on pre-packetized availability as needed for quality and resolution changes or other factors.

Clients 570-0 to 570-A can run streaming media players 572-0 to 572-A to play media received from the computing platform 502 or its delegate system (e.g., a CDN or storage node). Media can be received through packets transmitted through connection 550.

FIG. 6A depicts an example where a file is stored as multiple packets (e.g., Packets 1 to Packet N) for any or all of high definition, medium definition, or low definition. A single file can be represented and stored as multiple different levels of pre-transcoded video quality stored as packets that are available to be transmitted to a client. In the event of congestion management and adaptive bitrate streaming whereby a lower or higher definition file is to be streamed, packets for a lower or higher definition file are available to transmit, subject to updates to certain header fields as described herein.

A use case in CDNs that employ Real Time Streaming mechanisms such as RTP Control Protocol (RTCP) can occur with changing bandwidth uses. A degradation in bandwidth between sender and client receiver can lead to use of a lower stream quality. For example, if a content transmitter network interface receives a flow control message due to congestion, then the network interface can cause the quality of transmitted content to change to lower quality. If packet drops are detected at a receiver client, the network interface can cause the quality of transmitted content to change to lower quality (lower bandwidth) stream. According to some embodiments, the network interface can trigger changes in quality of transmitted content.

FIG. 6B depicts an example of adjusting between stream qualities due to changes in bandwidth availability between the transmitter and client. In this example, bandwidth degradation leads to a network interface reducing a quality level of a file from high definition to medium definition. Further bandwidth degradation leads to a network interface reducing a quality level of a file from medium definition to low definition. After bandwidth recovery, the network interface increases a quality level of a file from low definition to high definition.

Changing stream quality can involve use of pre-packetized files that are pre-generated and available for access from storage. As network congestion occurs and clears, the stream can be dynamically switched to a higher level of quality. Having multiple levels of quality stored in a single pre-packetized file would enable the ability to quickly switch between quality streams on the fly by changing the pointer to the next packet to the appropriate stream while maintaining time stamp ordering.

Packets can be stored in memory or storage in a manner that packet addresses of sequential packets (e.g., Packet 1 to Packet N) are associated with a virtual address that starts at 0x00000000 and increments for each successive packet. A physical address translation can be performed to determined physical storage location of a packet.

When switching quality levels, the time stamp or time code is to be synchronized or maintained to provide for continuous playback. According to various embodiments, a bitmask described next with respect to Table 1 provide for this transition. Table 1 depicts an example of using a bitmask to determine the how to seamlessly switch between quality levels within a proposed file format while maintaining time stamp ordering. A sample addressing scheme showing a manner to quickly the stream between quality levels within the file by updating the CurrentAddress's quality mask as determined by RTCP data. File contents would not be limited to three levels of quality but could include any number of different quality levels the provider deems adequate. In this example, the file size is not considered as only the bits for the current quality level are streamed.

TABLE 1

| Quality | Mask | Packet Address | | | | |
|---|---|---|---|---|---|---|
| High | 0x00000000 | 0x00000000 | 0x00000001 | 0x00000002 | 0x00000003 | 0x00000004 |
| Medium | 0x10000000 | 0x10000000 | 0x10000001 | 0x10000002 | 0x10000003 | 0x10000004 |
| Low | 0x20000000 | 0x20000000 | 0x20000001 | 0x20000002 | 0x20000003 | 0x20000004 |

For example, a Next Address of a packet can be determined from the logical operation of:
(CurrentAddress & 0x01111111)|(RTCP Indicated Quality Mask)

A CurrentAddress can represent an address of a packet that is to be streamed next for a current stream quality and before switching to another stream quality. To determine an address of a next packet in memory to retrieve to stream, the Next Address operation is performed. For high quality, the Next Address is an RTCP Indicated Quality Mask of 0x00000000 logically OR′d with a logical operation of (Current Address AND 0x01111111). For medium quality, the Next Address is an RTCP Indicated Quality Mask of 0x10000000 logically OR′d with a logical operation of (Current Address AND 0x01111111). For low quality, the Next Address is an RTCP Indicated Quality Mask of 0x20000000 logically OR′d with a logical operation of (Current Address AND 0x01111111).

Applications using RTCP can detect and indicate the level of quality the client is capable of and adjust the quality without the need to reference a timestamp table to determine where to pick up the stream and which packet to select to transmit from a different quality-level transcoded file. Rather, a next sequential packet from a chosen quality level can be selected and timestamp ordering is maintained by ordering addresses of packets and packet content according to continuing increasing playback time and using a bitmask applied to a packet storage address to determine an address of a packet of a different quality level.

RTP flows are spaced so as to arrive at the client at a pace that is similar to the rate at which the content is being rendered. Buffering accounts for minor jitter and minor arrival/render rate differences. Initial data in a stream (such as during initial buffering) can be sent at a much higher rate than the playback/rendering rate. Once the desired level of buffering is reached, the rate will reduce to match the playback rate. Similarly, if the control protocol determines that the buffer is too small or large, the RTP segmentation offload pacing rate managed by the network interface could be adjusted by the streaming control protocol to keep an optimal buffer size. Even in the same flow, it is possible to have a different pacing rate with each RTP segmentation offload packet generation operation. Similarly, user interactions such as jumping to new times/chapters or fast forwarding may cause a need for more buffering as the file will clear the existing buffer and replace it with content from the new section of the media file. For example, for an existing stream, if a quality level is changed, the network interface can adjust inter-packet gap to be smaller and provide bursty transmission for a new stream (e.g., different media file) or when fast forwarding or reversing to a different part of the same media file in an existing stream.

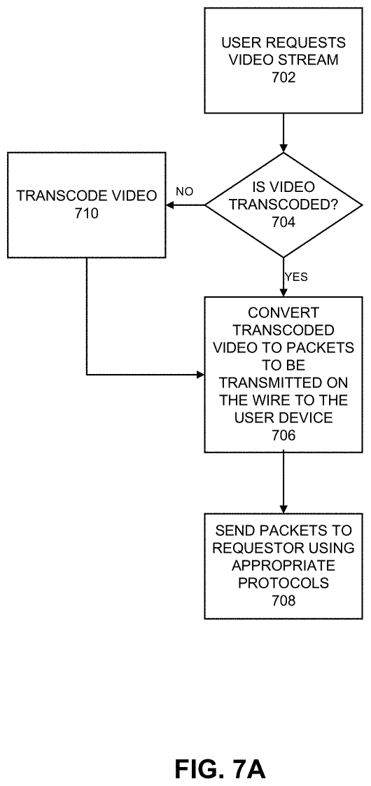

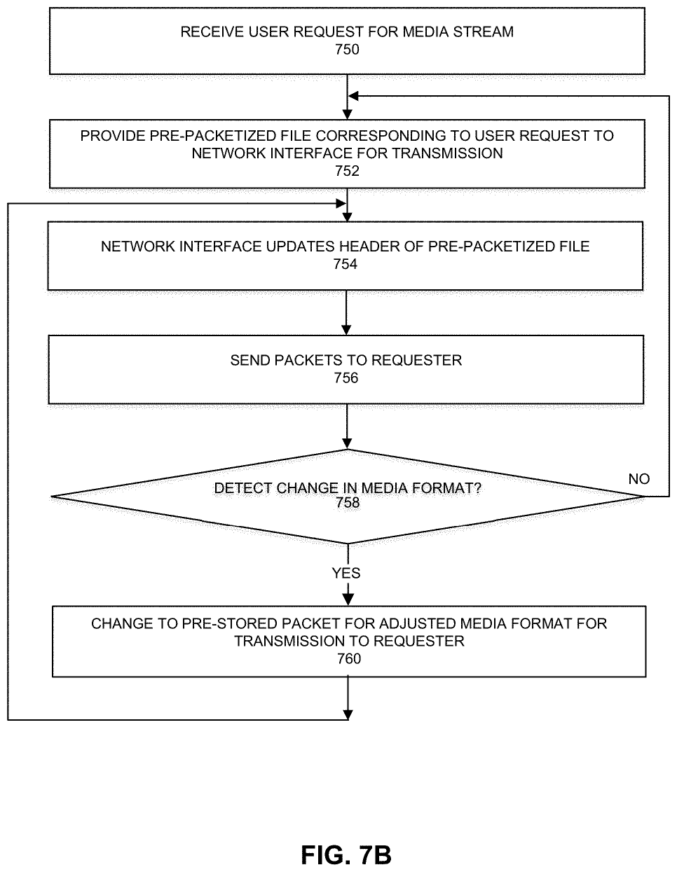

FIG. 7A depicts a process. This process can be used by various embodiments to transcode video in response to a user request. At 702, a user request for a video stream is received. The request can identify a media (e.g., video or audio), a quality level, an acceptable encoding format (e.g., H.264, H.265, VP8, VP9, MPEG, and so forth). At 704, a determination is made if the video is previously transcoded. If the video is previously transcoded to the desired quality or encoding format, the process continues to 706. If the video is not transcoded to the desired quality or encoding format, the process continues to 710.

At 706, the transcoded video is packetized using the applicable protocol for transmission to the user device. An applicable protocol can be RTP over TCP/IP, for example. At 708, generated packets are transmitted to the user device.

At 710, the video can be transcoded at a host computing platform to be transmitted to the user device. For example, transcoding can involve changing the quality level, video encoding format, changing or adding close captioning and so forth. The process continues to 706, described earlier.

FIG. 7B depicts a process. The process can be performed by a system that can offload certain header generation operations to a network interface. At 750, a network interface receives a user request for a media stream such as video or audio. At 752, a pre-packetized file for the requested media stream is provided for transmission to the network interface. The pre-packetized file can have header fields completed and include media content for the applicable quality level and encoding format. In some examples, some header fields such as sequence number, timestamp and validation value (e.g., checksum) can be left blank or with dummy content to be overwritten by a network interface. For example, an RTP header and TCP, UDP, or QUIC headers can be generated prior to the request and stored for use in response to a request. At 754, the network interface can generate and insert headers into the pre-packetized file portion. The network interface can use general purpose processor or a discrete controller to generate the header fields. At 756, the packet can be transmitted to the requester using a connection such as a wired or wireless network or fabric.

At 758, a determination is made if the media format is to change. For example, if a bandwidth available between the sender and receiver decreases or increases above a threshold level, the media format can be changed to lower or higher quality. In some examples, a requested encoded media format may change for example if a player used to playback media changes but continuity of playback of content is to continue. For a determination that the media format is to change, the process continues to 760. If the media format is not to change, the process continues to 752.

At 760, a pre-stored packet is selected for transmission for the adjusted media format. A pre-generated packet for the adjusted media format can be retrieved from memory or storage and provided to the network interface. The pre-generated packet can be selected such that a packet corresponding to the next time stamp is retrieved to continue transmission of media to the receiver in playback order. Various embodiments described herein can be used to select an address of the packet of the adjusted media format. The process continues to 754 for the network interface to selectively modify the pre-generated packet.

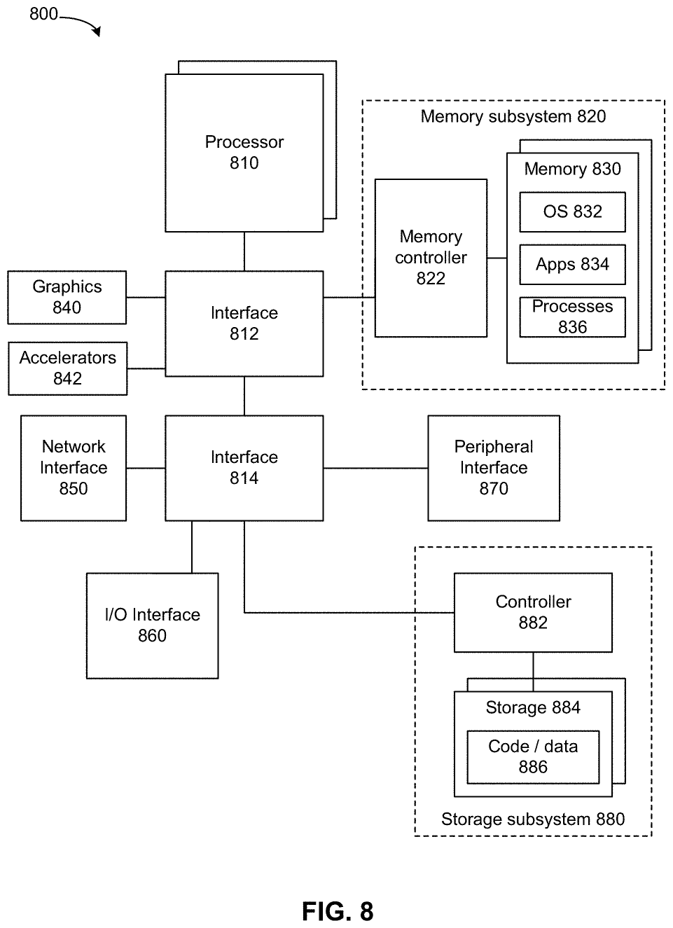

FIG. 8 depicts a system. The system can use embodiments described herein to offload header updates to a network interface or pre-packetize content of various media formats. System 800 includes processor 810, which provides processing, operation management, and execution of instructions for system 800. Processor 810 can include any type of microprocessor, central processing unit (CPU), graphics processing unit (GPU), processing core, or other processing hardware to provide processing for system 800, or a combination of processors. Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a fixed function offload engine that can be accessed or used by a processor 810. For example, an accelerator among accelerators 842 can provide compression (DC) capability, cryptography services such as public key encryption (PKE), cipher, hash/authentication capabilities, decryption, or other capabilities or services. In some embodiments, in addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. Various embodiments can be used in connection with network interface 850, processor 810, and memory subsystem 820.

In one example, system 800 includes one or more input/output (I/O) interface(s) 860. I/O interface 860 can include one or more interface components through which a user interacts with system 800 (e.g., audio, alphanumeric, tactile/touch, or other interfacing). Peripheral interface 870 can include any hardware interface not specifically mentioned above. Peripherals refer generally to devices that connect dependently to system 800. A dependent connection is one where system 800 provides the software platform or hardware platform or both on which operation executes, and with which a user interacts.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (i.e., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (i.e., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. Dynamic volatile memory uses refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WI02 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 800. More specifically, power source typically interfaces to one or multiple power supplies in system 800 to provide power to the components of system 800. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 800 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

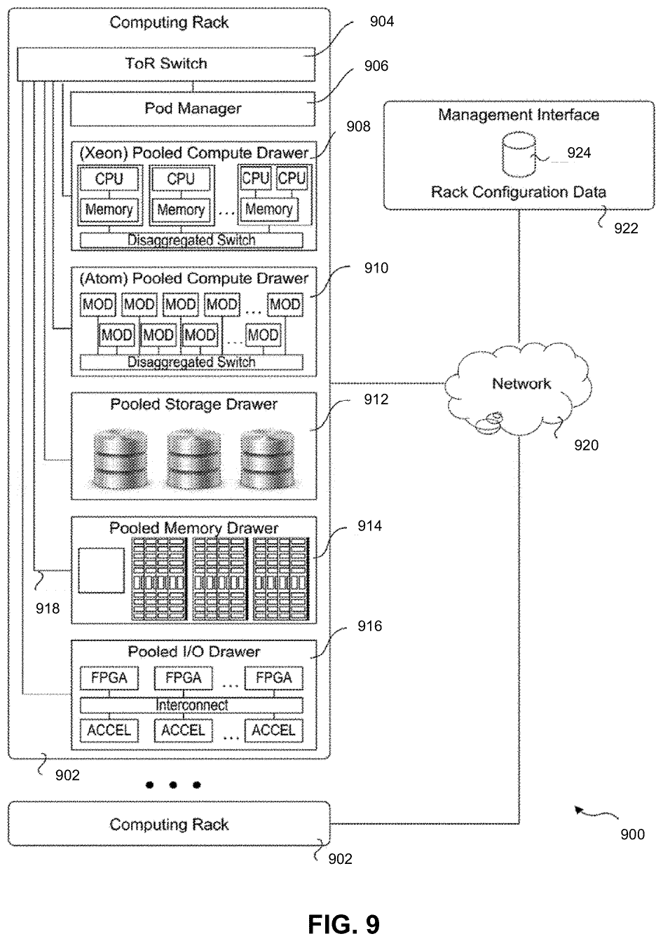

FIG. 9 depicts an environment 900 includes multiple computing racks 902, each including a Top of Rack (ToR) switch 904, a pod manager 906, and a plurality of pooled system drawers. Various embodiments can be used in a switch. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 908, and Intel® ATOM™ pooled compute drawer 910, a pooled storage drawer 912, a pooled memory drawer 914, and a pooled I/O drawer 916. Each of the pooled system drawers is connected to ToR switch 904 via a high-speed link 918, such as a 40 Gigabit/second (Gb/s) or 100 Gb/s Ethernet link or a 100+Gb/s Silicon Photonics (SiPh) optical link. In one embodiment high-speed link 918 comprises an 800 Gb/s SiPh optical link.

Multiple of the computing racks 902 may be interconnected via their ToR switches 904 (e.g., to a pod-level switch or data center switch), as illustrated by connections to a network 920. In some embodiments, groups of computing racks 902 are managed as separate pods via pod manager(s) 906. In one embodiment, a single pod manager is used to manage all of the racks in the pod. Alternatively, distributed pod managers may be used for pod management operations.

Environment 900 further includes a management interface 922 that is used to manage various aspects of the environment. This includes managing rack configuration, with corresponding parameters stored as rack configuration data 924.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Some examples include a method comprising an operating system querying a device driver for capabilities of a network interface and learning of a streaming protocol offload feature. The method can include a streaming media offload command being sent to the driver that identifies content to transmit and a prototype header.

Some examples include a method comprising a network interface preparing a packet using streaming media offload capabilities of the network interface. The method can include the network interface copying a prototype header into a transmit memory buffer; reading a segment worth of data from system memory and copying the data into a memory buffer; updating at least one streaming protocol header portion of the prototype header and one or more transport layer header fields for the packet.

Example 1 includes an apparatus that includes a network interface comprising: a real-time streaming protocol offload circuitry to update at least one streaming protocol header field for a packet and provide the packet for transmission to a medium.

Example 2 includes any example, wherein the at least one streaming protocol header field is based on a streaming media protocol and comprises one or more of a sequence number or a time stamp.

Example 3 includes any example, wherein the offload circuitry is to generate a pseudo-random starting sequence number, update the sequence number for a subsequent packet transmission, and include a value derived from the generated sequence number in at least one header field.

Example 4 includes any example, wherein the offload circuitry is to generate a time stamp based on one or more of: an initial timestamp value, a clock rate, or a number of bytes sent and the offload circuitry is to is to include the generated time stamp in at least one header field.

Example 5 includes any example, wherein the offload circuitry is to generate a validation value for a transport layer protocol based on the packet with the updated at least one header field.

Example 6 includes any example, wherein the network interface comprises a memory and the memory is to receive a copy of a prototype header and the offload circuitry is to update at least one header field of the prototype header.

Example 7 includes any example, and includes a computing platform communicatively coupled to the interface, wherein the computing platform comprises a server, data center, rack, or host computing platform.

Example 8 includes any example, and includes a computing platform communicatively coupled to the interface, wherein the computing platform is to execute an operating system that is to provide a segmentation offload command that identifies content to be transmitted.

Example 9 includes any example, wherein the packet comprises a media file portion that was generated and stored prior to a request for the media file portion.

Example 10 includes any example, and includes a computing platform communicatively coupled to the interface, the computing platform to store pre-packetized files for at least one media quality level.

Example 11 includes any example, wherein the network interface comprises a processor to detect a change in a traffic receipt rate and to modify a quality level of media to a second quality level provided for transmission in a packet.

Example 12 includes any example, wherein to modify a quality level of media to a second level provided for transmission in a packet, the network interface is to select a pre-generated packet associated with a next time stamp for the second quality level.

Example 13 includes a non-transitory computer-readable medium comprising instructions stored thereon, that if executed by at least one processor, cause the at least one processor to: provide a media streaming protocol packet segmentation offload request to a network interface, the request specifying a segment of content to transmit and metadata associated with the content and cause a network interface to update at least one header field value for a packet prior to transmission of the packet.

Example 14 includes any example, wherein the at least one header field comprises one or more of a sequence number or a time stamp.

Example 15 includes any example, and includes instructions stored thereon, that if executed by at least one processor, cause the at least one processor to: cause the network interface to generate a validation value for a transport layer protocol based on the packet with the updated at least one header field.

Example 16 includes any example, and includes instructions stored thereon, that if executed by at least one processor, cause the at least one processor to: pre-packetize and store at least one file for at least one media quality level prior to a request for the at least one file.

Example 17 includes a system comprising: a computing platform comprising at least one processor and at least one memory, wherein: the at least one processor is to provide a streaming file packet segmentation offload request to a network interface, the request specifying a segment of content to transmit and metadata associated with the content and a network interface, wherein the network interface comprises an offload circuitry to update at least one header field of a packet comprising the segment of content and prior to transmission.

Example 18 includes any example, wherein the at least one header field is based on Real-time Transport Protocol (RTP) and comprises one or more of a sequence number or a time stamp.

Example 19 includes any example, wherein the offload circuitry is to perform one or more of: generate a pseudo-random starting sequence number, update the sequence number for subsequent a packet transmission, and include the generated sequence number in at least one header field or generate a time stamp based on one or more of: an initial timestamp value, a clock rate, or a number of bytes sent and the offload circuitry is to is to include the generated time stamp in at least on header field.

Example 20 includes a method performed at a media server, the method comprising: for a media file, storing a packetized version of the media file comprising payload and fields of some headers before a request is received to transmit the media file.

What is claimed is:

1. An apparatus comprising:
a network interface comprising:
a real-time streaming protocol offload circuitry to update at least one streaming protocol header field for a packet and provide the packet for transmission to a medium.

2. The apparatus of claim 1, wherein the at least one streaming protocol header field is based on a streaming media protocol and comprises one or more of a sequence number or a time stamp.

3. The apparatus of claim 1, wherein the offload circuitry is to generate a pseudo-random starting sequence number, update the sequence number for a subsequent packet transmission, and include a value derived from the generated sequence number in at least one header field.

4. The apparatus of claim 1, wherein the offload circuitry is to generate a time stamp based on one or more of: an initial timestamp value, a clock rate, or a number of bytes sent and the offload circuitry is to is to include the generated time stamp in at least one header field.

5. The apparatus of claim 1, wherein the offload circuitry is to generate a validation value for a transport layer protocol based on the packet with the updated at least one header field.

6. The apparatus of claim 1, wherein the network interface comprises a memory and the memory is to receive a copy of a prototype header and the offload circuitry is to update at least one header field of the prototype header.

7. The apparatus of claim 1, comprising a computing platform communicatively coupled to the interface, wherein the computing platform comprises a server, data center, rack, or host computing platform.

8. The apparatus of claim 1, comprising a computing platform communicatively coupled to the interface, wherein the computing platform is to execute an operating system that is to provide a segmentation offload command that identifies content to be transmitted.

9. The apparatus of claim 1, wherein the packet comprises a media file portion that was generated and stored prior to a request for the media file portion.

10. The apparatus of claim 9, comprising a computing platform communicatively coupled to the interface, the computing platform to store pre-packetized files for at least one media quality level.

11. The apparatus of claim 9, wherein the network interface comprises a processor to detect a change in a traffic receipt rate and to modify a quality level of media to a second quality level provided for transmission in a packet.

12. The apparatus of claim 11, wherein to modify a quality level of media to a second level provided for transmission in a packet, the network interface is to select a pre-generated packet associated with a next time stamp for the second quality level.

13. A non-transitory computer-readable medium comprising instructions stored thereon, that if executed by at least one processor, cause the at least one processor to:
provide a media streaming protocol packet segmentation offload request to a network interface, the request specifying a segment of content to transmit and metadata associated with the content and
cause a network interface to update at least one header field value for a packet prior to transmission of the packet.

14. The non-transitory computer-readable medium of claim 13, wherein the at least one header field comprises one or more of a sequence number or a time stamp.

15. The non-transitory computer-readable medium of claim 13, comprising instructions stored thereon, that if executed by at least one processor, cause the at least one processor to:
cause the network interface to generate a validation value for a transport layer protocol based on the packet with the updated at least one header field.

16. The non-transitory computer-readable medium of claim 13, comprising instructions stored thereon, that if executed by at least one processor, cause the at least one processor to:
pre-packetize and store at least one file for at least one media quality level prior to a request for the at least one file.

17. A system comprising:
a computing platform comprising at least one processor and at least one memory, wherein:
the at least one processor is to provide a streaming file packet segmentation offload request to a network interface, the request specifying a segment of content to transmit and metadata associated with the content and
a network interface, wherein
the network interface comprises an offload circuitry to update at least one header field of a packet comprising the segment of content and prior to transmission.

18. The system of claim 17, wherein the at least one header field is based on Real-time Transport Protocol (RTP) and comprises one or more of a sequence number or a time stamp.

19. The system of claim 17, wherein the offload circuitry is to perform one or more of:
generate a pseudo-random starting sequence number, update the sequence number for subsequent a packet transmission, and include the generated sequence number in at least one header field or
generate a time stamp based on one or more of: an initial timestamp value, a clock rate, or a number of bytes sent and the offload circuitry is to is to include the generated time stamp in at least on header field.

20. A method performed at a media server, the method comprising:
for a media file, storing a packetized version of the media file comprising payload and fields of some headers before a request is received to transmit the media file.
